(19) United States
(12) Patent Application Publication
(10) Pub. No.: US 2014/0029667 A1
(43) Pub. Date: Jan. 30, 2014

(54) METHOD OF CODING AN IMAGE EPITOME

(71) Applicants: Safa Cherigui, Villeurbannes (FR); Dominique Thoreau, Cesson Sevigne (FR); Christine Guillemot, Chantepie (FR)

(72) Inventors: Safa Cherigui, Villeurbannes (FR); Dominique Thoreau, Cesson Sevigne (FR); Christine Guillemot, Chantepie (FR)

(73) Assignee: THOMSON LICENSING, ISSY DE MOULINEAUX (FR)

(21) Appl. No.: 13/980,889

(22) PCT Filed: May 24, 2011
(86) PCT No.: PCT/EP11/58495

§ 371 Date: Oct. 14, 2013

(30) Foreign Application Priority Data
Jan. 21, 2011 (EP) 11305063.7

(51) Int. Cl. H04N 7/50

(52) U.S. Cl. CPC H04N 19/00781
USPC 375/240.12

(57) ABSTRACT

A method of coding an image epitome is disclosed. The method of coding comprises:
creating the epitome of the image, the epitome comprising a texture epitome and a transform map;
coding the texture epitome and the transform map;
   wherein texture epitome is padded, before the step of coding, such that the texture epitome is block aligned.

### FIELD OF THE INVENTION

The invention relates to image epitome extraction in general, in the context of video compression/coding constraint. More precisely, the invention relates to a method of coding an epitome.

### BACKGROUND OF THE INVENTION

The epitome of an image is its condensed representation containing the essence of the textural and structures properties of the image. The epitome approach aims at reducing redundant information (texture) in the image by exploiting repeated content within an image. An epitome construction method is known from the article from Hoppe et al entitled “Factoring Repeated Content Within and Among Images” and published in the proceedings of ACM SIGGRAPH 2008 (ACM Transaction on Graphics, vol. 27, no. 3, pp. 1-10, 2008).

This epitome construction method consists in factoring an image into a texture epitome and a transform map. Once the self similarity content is determined, the following step of the algorithm consists in extracting redundant texture patches to construct epitome charts, the union of all epitome charts constituting the texture epitome. Each epitome chart represents repeated regions in the image. The construction of an epitome chart is composed of a chart initialization step following of several chart extension steps. The transform map indicates for each block of the image which patch in the texture epitome is to be used for its reconstruction). The reconstruction may be a simple copy of the identified patch. If sub-pel reconstruction is used then an interpolation is made.

FIG. 1 depicts the encoding of an epitome according to the prior art. During a step 10, the epitome is constructed. This step is known as Image factorization. At step 12, the texture epitome is encoded into a first bitstream. At step 14, the transform map is encoded into a second bitstream. As an example, H.264 coding standard defined in document ISO/IEC 14496-10 can be used to encode the texture epitome. H.264 specifies three different intra prediction modes, Intra4×4, Intra8×8 and Intra16×16 that correspond to a spatial estimation of the block to be coded. These different modes can exploit different directional prediction modes in order to build the block pixels prediction. In Intra4×4 and Intra8×8, nine intra prediction modes are defined. Eight of these modes consist of a 1D directional extrapolation of pixels surrounding the block to be predicted. The additional prediction mode (DC mode) defines the predicted block pixels as the average of available surrounding pixels. In addition, the block of the error residual of prediction between the original block and its spatial prediction is transformed using a Discrete Cosine Transform (DCT). If applied directly on the texture epitome such an encoding is costly.

More generally, encoding such a texture epitome with existing block-based encoding techniques is costly because of texture edges existing within blocks to be encoded.

### 3. BRIEF SUMMARY OF THE INVENTION

The invention is aimed at alleviating at least one of the drawbacks of the prior art. To this aim, the invention relates to a method of coding an epitome of an image divided into blocks comprising the steps of:
creating the epitome of the image comprising a texture epitome and a transform map;
coding the texture epitome and the transform map;
wherein the texture epitome is padded, before the step of coding, such that the texture epitome is block aligned.

According to a first embodiment, the texture epitome is padded after the step of creation of the epitome and wherein the method further comprises, before the coding step, a step of refining the transform map using the padded texture epitome.

According to a specific aspect of the invention, refining the transform map comprises, for each block of the image, identifying a patch in the padded epitome which best match the block according to a criterion.

According to a second embodiment, the texture epitome is padded during the step of epitome creation.

Advantageously, the transform map is refined using the padded texture epitome padded during the step of epitome creation.

### 4. BRIEF DESCRIPTION OF THE DRAWINGS

Other characteristics and advantages of the invention will appear through the description of a non-limiting embodiment of the invention, which will be illustrated, with the help of the enclosed drawing.

FIG. 1 depicts the encoding of an epitome according to the prior art;

FIG. 2 depicts the encoding of an epitome according to a first embodiment of the invention;

FIG. 3 represents a first detail of the method of coding according to the second embodiment of the invention;

FIG. 4 illustrates an epitome chart initialization step;

FIG. 5 represents a second detail of the method of coding according to the second embodiment of the invention;

FIG. 6 illustrates an epitome chart extension step;

FIG. 7 depicts the encoding of an epitome according to a second embodiment of the invention;

FIG. 8 depicts the encoding of an epitome according to a third embodiment of the invention;

FIG. 9 represents a source image;

FIG. 10 represents a texture epitome (a), a padded texture epitome (b) and the pixel by pixel difference between padded texture epitome and non padded texture epitome (c); and

FIG. 11 depicts a coding device according to the invention.

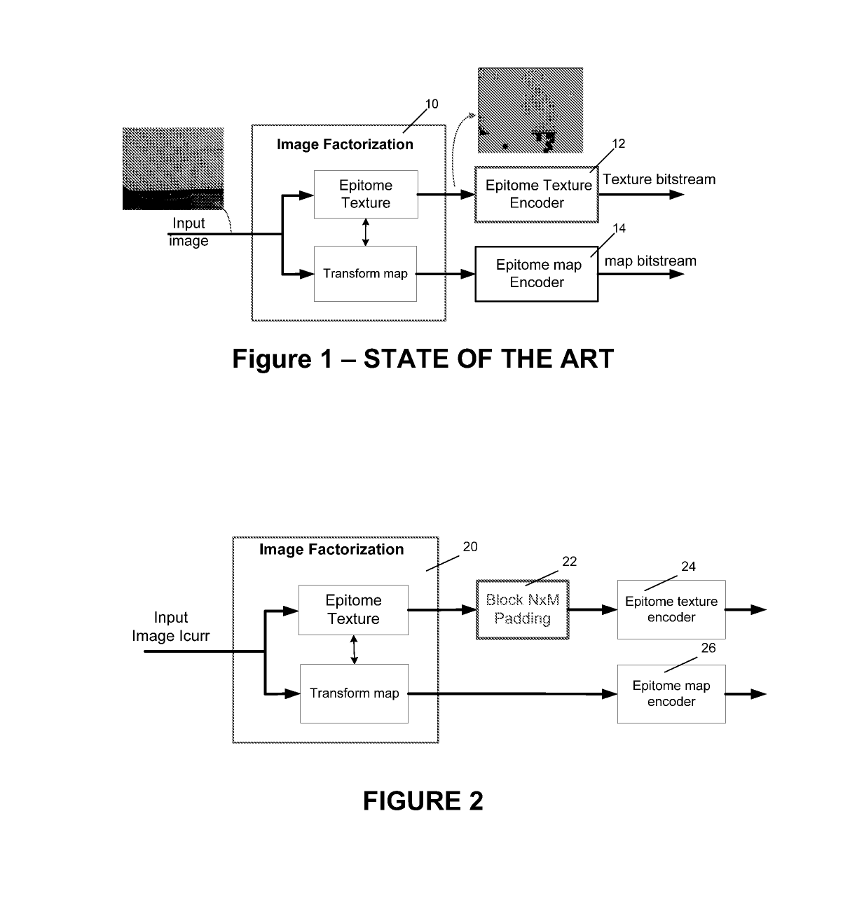

### 5. DETAILED DESCRIPTION OF THE INVENTION

One goal is to propose a complementary tool to be used while extending an epitome by an image region. The invention concerns the consideration of video compression algorithm properties (used to encode the epitome) in building of the epitome.

The invention relates to a coding method of an epitome. The epitome of an image comprises a texture epitome comprising patches of texture extracted from the image and a transform map. The texture epitome is such that all image blocks can be reconstructed from the epitome patches. The transform map is also known as assignation map or vector map in the literature. The transform map indicates, for each block of the image, the location in the texture epitome of the patch used to reconstruct it. With the texture epitome E and the transform map Φ, one is able to reconstruct an image.

The present invention enables the optimization of Image Factorization, i.e. epitome creation, according to the future use of block based transforms such as DCT by realizing a texture padding in order to have a block structure in the epitome and optionally, by operating a “refinement” of the epitome due to the addition of new pixels to the epitome for the padding process. The refinement operation comprises finding new patches in the texture epitome taken into account the new pixels issued from the padding process.

FIG. 2 represents the coding method according to a first embodiment of the invention.

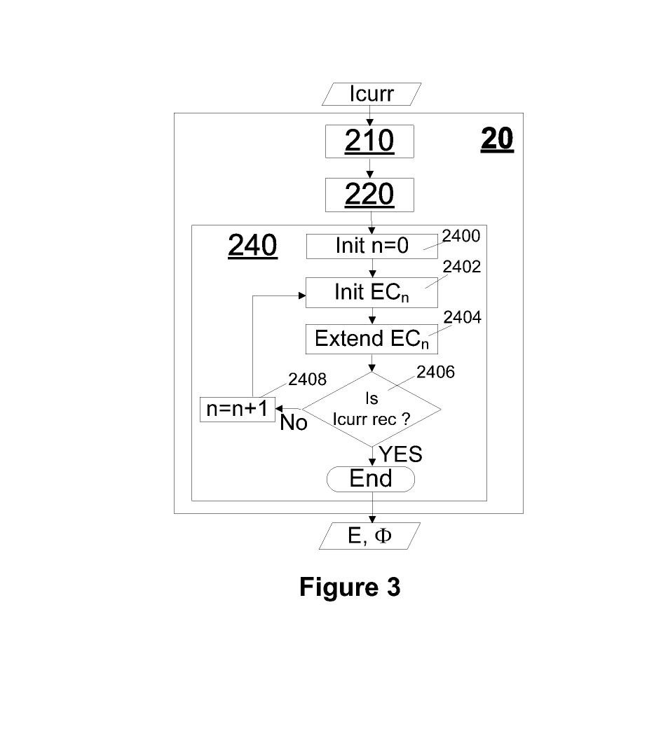

At step 20, an epitome, i.e. a texture epitome E and a transform map Φ are created from the current image Icurr. The epitome of an image is its condensed representation containing the essence of the textural and structure properties of the image. Therefore, according to this specific embodiment, the current image Icurr is factorized, i.e. a texture epitome E and a transform map Φ are created for the current image. The epitome principle was first disclosed by Hoppe et al in the article entitled “Factoring Repeated Content Within and Among Images” published in the proceedings of ACM SIGGRAPH 2008 (ACM Transaction on Graphics, vol. 27, no. 3, pp. 1-10, 2008). The texture epitome E is constructed from pieces of texture (e.g. a set of charts) taken from the current image. The transform map Φ is an assignation map that keeps track of the correspondences between each block of the current image Icurr and a patch of the texture epitome E. From an image I, a texture epitome E and a transform map Φ are created such that all image blocks can be reconstructed from matched epitome patches. A matched patch is also known as transformed patch. The transform map is also known as vector map or assignment map in the literature. With the texture epitome E and the transform map Φ, one is able to reconstruct the current image I′. In the following the epitome designates both the texture epitome E and the transform map Φ. FIG. 3 illustrates a method for epitome creation. However, the invention is not at all limited to this method of epitome creation.

Others forms of epitome have been proposed in the literature. In document entitled “Summarizing visual data using bidirectional similarity” published in 2008 in Computer Vision and Pattern Recognition CVPR, Simakov et al disclose the creation of an image summary from a bi-directional similarity measure. Their approach aims at satisfying two requirements: containing as much as possible visual information from the input data while introducing as few as possible new visual artifacts that were not in the input data (i.e., while preserving visual coherence).
In document entitled “Video Epitomes” published in International Journal of Computer Vision, vol. 76, No. 2, February 2008 image Cheung et al disclose a statistical method in order to extract an epitome. This approach is based on a probabilistic model that captures both the color information and certain spatial pattern.

At step 210, the epitome construction method comprises finding self-similarities within the current image Icurr. The current image is thus divided into a regular grid of blocks. For each block in the current image Icurr, one searches the set of patches in the same image with similar content. That is, for each block Bᵢ(∈ block grid), a list L_{match}(Bᵢ)={M_{i,0}, M_{i,1} . . . } of matches (or matched patches) is determined that approximate Bᵢ with a given error tolerance ε. In the current embodiment, the procedure of matching is performed with a block matching algorithm using an average Euclidian distance. Therefore, at step 210, the patches M_{j,l} in the current image whose distance to the block Bi is below ε are added to the list L_{match}(Bᵢ). The distance equals for example the absolute value of the pixel by pixel difference between the block Bi and the patch M_{j, l} divided by the number of pixels in Bᵢ. According to a variant, the distance equals the SSE (Sum of Square Errors), wherein the errors are the pixel by pixel difference between the block Bi and the patch M_{j,l}. An exhaustive search is performed in the entire image. Once all the match lists have been created for the set of image blocks new lists L′_{match}(M_{j,l}) indicating the set of image blocks that could be represented by a matched patch M_{j,l}, are built at step 220. Note that all the matched blocks M_{j,l} found during the full search step are not necessarily aligned with the block grid of the image and thus belong to the “pixel grid”.

At step 240, epitome charts are constructed. To this aim, texture patches are extracted, more precisely selected, in order to construct epitome charts, the union of all the epitome charts constituting the texture epitome E. Each epitome chart represents specific regions of the image in term of texture. Step 240 is detailed in the following.

At step 2400, an index n is set equal to 0, n is an integer.

At step 2402, a first epitome chart ECₙ is initialized. Several candidate matched patches can be used to initialize an epitome chart. Each epitome chart is initialized by the matched patch which is the most representative of the not yet reconstructed remaining blocks. Let Y∈R^{N×M} denote the input image and let Y′∈R^{N×M} denote the image reconstructed by a candidate matched patch and the epitome charts previously constructed. To initialize a chart, the following selection criterion based on the minimization of the Mean Square Error (MSE) criterion is used:

$${FC}_{init} = min ( \frac{{\sum }_{i = 1}^{N} {\sum }_{j = 1}^{M} ( {Y}_{i , j} - {Y}_{i , j}^{′} )}{N \times M} ) \qquad ( 1 )$$

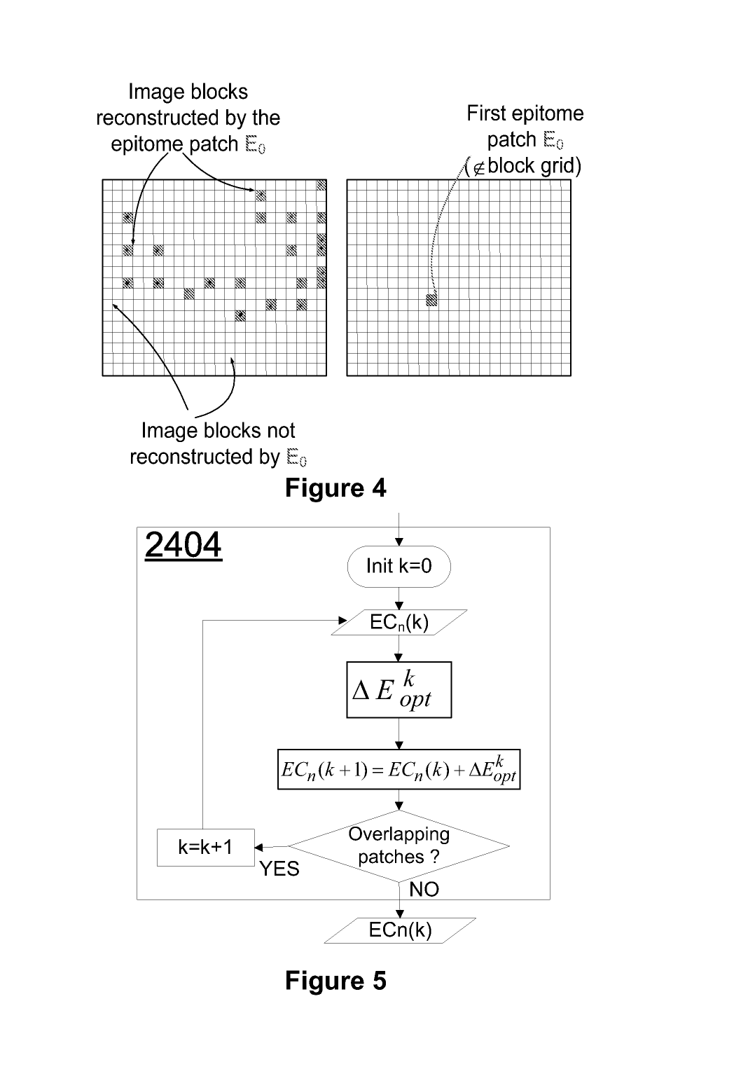

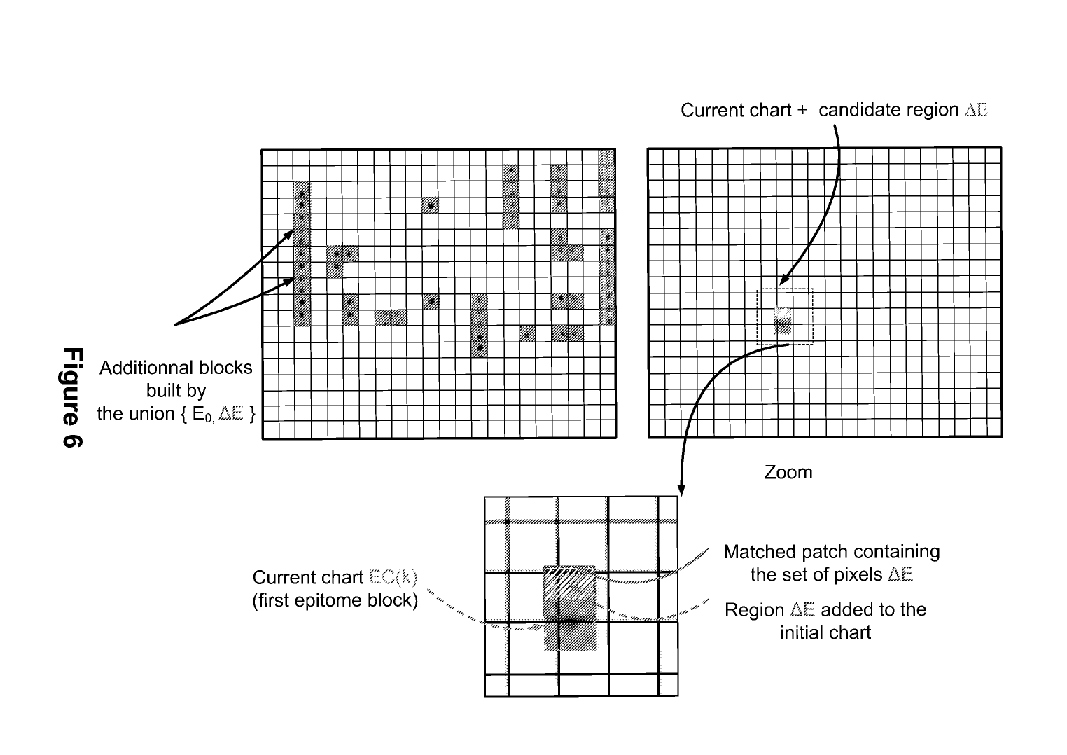

The selected criterion takes into account the prediction errors on the whole image. This criterion allows the epitome to be extended by a texture pattern that allows the reconstruction of the largest number of blocks while minimizing the reconstruction error. In the current embodiment, a zero value is assigned to image pixels that have not yet been predicted by epitome patches when computing the image reconstruction error. FIG. 4 shows the image blocks reconstructed once the first epitome patch E0 is selected.
At step 2404, the epitome chart ECₙ is then progressively grown by a region from the input image. The step is detailed on FIG. 5. Each time the epitome chart is enlarged, one keeps track of the number of additional blocks which can be predicted in the image as depicted on FIG. 6. This step is also known as epitome chart extension. The initial epitome chart ECₙ(0) corresponds to the texture patch retained at the initialization step. The epitome growth step proceeds first by determining the set of matched patches M_{j,l} that overlap the current chart ECₙ(k) and represent other image blocks. Therefore, there are several candidates regions ΔE that can be used as an extension of the current epitome chart. For each chart growth candidate ΔE, the supplement image blocks that could be reconstructed is determined from the list L′_{match}(M_{j,k}) related only to the matched patch M_{j,k} containing the set of pixels ΔE. Then, the optimal candidate ΔEₒₚₜ among the set of the candidate chart growth found, leading to best match according to a rate distorsion criterion is selected. Let Y∈R^{N×M} denote the input image and let Y′∈R^{N×M} denote the image reconstructed by the current epitome E_{curr} and a chart growth candidate ΔE. Note that the current epitome E_{curr} is composed of previously constructed epitome charts and the current epitome chart ECₙ(k). This selection is indeed conducted according to a minimization of a lagrangian criterion FCₑₓₜ

$${FC}_{ext} = min ( {D}_{{E}_{curr} + Δ E} + λ * {R}_{{E}_{curr} + Δ E} ) with {E}_{curr} = {\sum }_{i = 0}^{n} {EC}_{i}$$

$$Δ {E}_{opt}^{k} = {argmin}_{m} ( \frac{{\sum }_{i}^{N} {\sum }_{j}^{M} ( {Y}_{i , j} - {Y}_{i , j}^{′} )}{N * M} + λ * ( \frac{{E}_{curr} + Δ E}{N * M} ) )$$

In the preferred embodiment, the λ value is set to 1000. The first term of the criterion refers to the average prediction error per pixel when the input image is reconstructed by texture information contained in the current epitome

$${E}_{curr} = {\sum }_{i = 0}^{n} {EC}_{i}$$

and the increment ΔE. As in the initialization step when the image pixels are impacted neither by the current epitome E_{curr} nor by the increment, a zero value is assigned to them. FCₑₓₜ is thus computed on the whole image and not only on the reconstructed image blocks. The second term of the criterion corresponds to a rate per pixel when constructing the epitome, which is roughly estimated as the number of pixels in the current epitome and its increment, divided by the total number of pixels in the image. After having selected the locally optimal increment ΔEₒₚₜ, the current epitome chart becomes: ECₙ(k+1)=ECₙ(k)+ΔEₒₚₜ. The assignation map is updated for the blocks newly reconstructed by ECₙ(k+1).
Then, the current chart is extended, during next iteration k+1, until there are no more matched patches M_{j,l} which overlap the current chart ECₙ(k) and represent others blocks. If such overlapping patches exist then the method continues at step 2404 with ECₙ(k+1). When the current chart cannot be extended anymore and when the whole image is not yet reconstructed by the current epitome (step 2406), the index n is incremented by 1 at step 2408 and another epitome chart is created at a new location in the image. The method thus continues with the new epitome chart at step 2402, i.e. the new chart is first initialized before its extension. The process ends when the whole image is reconstructed by the epitome (step 2406). The texture epitome E comprises the union of all epitome charts ECₙ. The assignation map indicates for each block Bi of the current image the location in the texture epitome of the patch used for its reconstruction.

Back to FIG. 2, at step 22, the texture epitome is padded with the texture of the original image such that the padded texture epitome is aligned on the image grid (e.g. on the 8×8 block structure). More precisely, the size of the block taken into consideration for the padding step depends on the transform size (e.g. N×M with N and M integer) used during coding of the texture epitome. Indeed, coding method usually (for example H264) applies a DCT on the prediction error residual before quantization and VLC encoding. In step 20, during the process of the Image Factorization (Epitome building), if the epitome is built without precaution, the epitome structure is of an “ordinary” shape. This kind of shape comprises artificial texture edges between epitome/no epitome, i.e. Of texture/no texture. These edges inside the 4×4 or 8×8 blocks increase drastically the necessarily encoding cost of the texture. To this aim, the texture epitome is padded. More precisely, each block in the texture epitome that is not completely filled with texture is padded by copying the texture of the corresponding pixel of the image Icurr.

At step 24, the padded texture epitome is coded. Even if more texture than needed is coded due to the padded pixels, the global texture encoding cost is lower than without padding. As an example the texture epitome E is encoded in conformance with H.264 standard using intra only coding mode. According to a variant, the texture epitome is encoded in conformance with JPEG standard. According to another variant, the texture epitome is encoded in inter coding mode using as reference image an homogenous image, e.g. an image whose pixels all equal 128. According to another variant, the texture epitome is encoded using a classical encoder (e.g. H.264, MPEG2, etc) using both intra and inter prediction modes. These methods usually comprise the steps of computing a residual signal from a prediction signal, DCT, quantization and entropy coding.

At step 26, the transform map c is encoded with a fixed length code (FLC) or variable length code (VLC). But others can be used also (CABAC . . . ).The transform map is a map of vectors also referred as vector map.

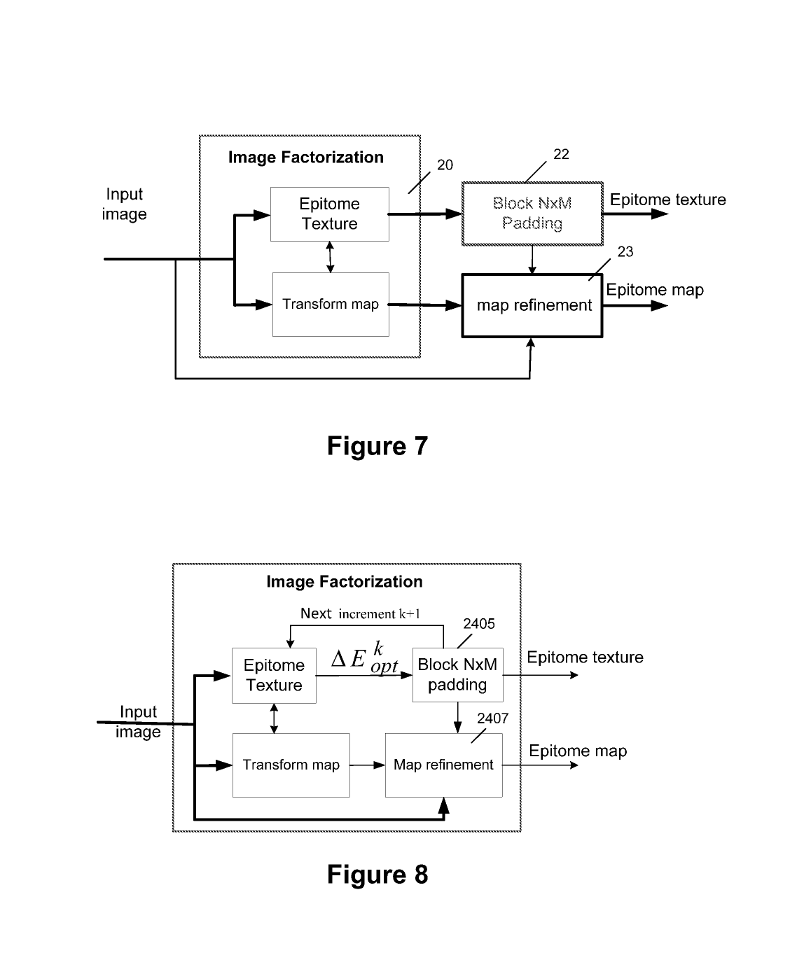

FIG. 7 represents a second embodiment of the coding method according to the invention. The step identical to the steps of first embodiment described with respect to FIG. 2 are identified with the same numerical references.

The coding method comprises a step 20 of epitome creation and a step 22 of padding of the texture epitome.

The coding method further comprises a step 23 of transform map refinement. Indeed, step 22, the texture epitome is slightly modified, i.e. new pixels are added to the texture epitome so that the texture epitome is aligned on the block structure of the image. Consequently the transform map created at step 20 is not anymore optimized for the new texture epitome. During step 23, each block Bi in the current image Icurr is associated with the patch of the padded texture epitome with which it better matches in the sense of a criterion such as an Euclidean distance. The transform map is thus modified by changing for the current block the identifier of the matched patch. The identifier is for example the absolute coordinates of the matched patched in the texture epitome or the coordinate of a translational vector. More complex transformation may be used to associate a block of the current image to a patch in the texture epitome.

FIG. 8 represents a third embodiment of the coding method according to the invention. The step identical to the steps of first embodiment described with respect to FIGS. 2 and 3 are identified with the same numerical references.

In this case the padding of the texture epitome and the transform map refinement are achieved on the fly, i.e. during epitome creation step 20. At iteration k of step 2404 (chart extension step), the best increment ΔEₒₚₜ^{k} is determined.

At step 2405, the current epitome is padded to have a block structure. The transform map is not anymore optimized for the new texture epitome. During step 2407, each block Bi in the current image Icurr is associated with the patch of the padded texture epitome with which it better matches in the sense of a criterion such as an Euclidean distance. The transform map is thus modified by changing for the current block the identifier of the matched patch. The identifier is for example the coordinates of the matched patched in the texture epitome.
Then, the current chart ECₙ is extended, during next iteration k+1, are no more matched patches M_{j,l} which overlap the current chart ECₙ(k) and represent others blocks. When the current chart cannot be extended anymore and when the whole image is not yet reconstructed by the current epitome (step 2406), the index n is incremented by 1 at step 2408 and another epitome chart is created at a new location in the image. The method thus continues with the new epitome chart at step 2402, i.e. the new chart is first initialized before its extension. The process ends when the whole image is reconstructed by the epitome (step 2406).

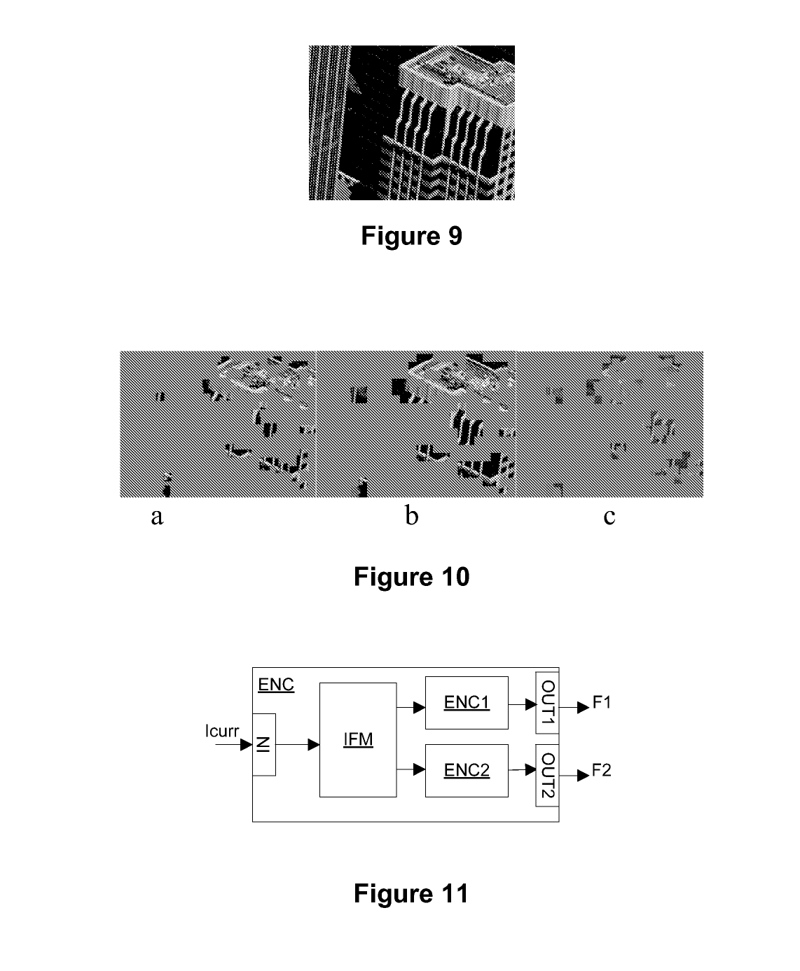

FIG. 9 represents a source image. FIG. 10a represent a texture epitome, FIG. 10b represents the padded texture epitome and FIG. 10c represents the pixel by pixel difference between padded texture epitome and non padded texture epitome.

Compared to the epitome construction method according to the state of the art approach, the invention has the advantages of decreasing the epitome encoding cost in comparison to the initial non padded epitome.

The epitome (E,Φ) being used to reconstruct an image from the epitome texture E and the vector map Φ, the invention offers better encoding performances in so far as:
the encoding cost of the texture of the epitome is decreased,
the Psnr of the image reconstructed from the decoded epitome is improved.

The main targeted applications are all the domains concerned with the image epitome reduction. Applications related to video compression and representations of videos are concerned.

FIG. 11 represents an coding device ENC according to the invention. The coding device ENC comprises an input IN. The input IN is linked to an image factorization module IFM. The module IFM is adapted to create a padded epitome according to the step 22 of the method of coding. According to an improved embodiment the module IFM is further adapted to refine the transform map according to the step 23 of the method of coding.

The module IFM is linked to a first encoding module ENC1 adapted to encode the texture epitome according to the step 24 of the method of coding into a first bitstream F1. The module IFM is further linked to a second encoding module ENC2 adapted to encode the transform map according to the step 26 of the method of coding into a second bitstream F2. Each output of the encoding modules ENC1 and ENC2 is connected to an output of the encoding device (OUT1 and OUT2). In another embodiment the coding device ENC further comprises a multiplexing module MUX connected to the outputs of both encoding modules ENC1 and ENC2. The multiplexing module MUX is adapted to multiplex both bitstreams F1 and F2 into a single bitstream. In this case the coding device comprises only one output.

In another embodiment the module IFM is adapted to both pad the texture epitome and refine the transform map on the fly according to the step of the coding method.

1. A method of coding an epitome of an image divided into blocks comprising:
creating the epitome of the image, said epitome comprising a texture epitome and a transform map;
coding the texture epitome and the transform map;
wherein the texture epitome is padded with the texture of said image, before the step of coding, such that the texture epitome is block aligned.

2. The method according to claim 1, wherein the texture epitome is padded after the step of creation of the epitome and wherein the method further comprises, before the coding step, a step of refining the transform map using the padded texture epitome.

3. The method according to claim 2, wherein refining the transform map comprises
for each block of the image, identifying a patch in the padded texture epitome which best match the block according to a criterion,

4. The method according to claim 1, wherein the texture epitome is padded during the step of epitome creation.

5. The method according to claim 4, wherein the transform map is refined using the padded texture epitome padded during the step of epitome creation.

6. A device for coding an epitome of an image divided into blocks comprising:
a module configured to create the epitome of the image, said epitome comprising a texture epitome and a transform map;
a module configured to code the texture epitome and the transform map;
wherein the device for coding is configured to pad, before the coding, the texture epitome with the texture of said image such that the texture epitome is block aligned.

7. The device according to claim 6, wherein the texture epitome being padded after the creation of the epitome, the device for coding is further configured to refine, before the coding, the transform map using the padded texture epitome.

8. The device according to claim 7, wherein refining the transform map comprises for each block of the image, identifying a patch in the padded texture epitome which best match the block according to a criterion.

9. The device according to claim 6, wherein the texture epitome is padded during the epitome creation.

10. The device according to claim 9, wherein the transform map is refined using the padded texture epitome padded during the epitome creation.
